(19) United States
(12) Patent Application Publication
(10) Pub. No.: US 2020/0131321 A1
(43) Pub. Date: Apr. 30, 2020

(54) PROCESS FOR PREPARING A BIAXIALLY ORIENTED MULTILAYERED FILM

(71) Applicant: DSM IP Assets B.V., Heerlen (NL)

(72) Inventors: Alexander Antonius Marie STROEKS, Echt (NL); Hao CHEN, Echt (NL)

(21) Appl. No.: 16/606,424

(22) PCT Filed: Apr. 19, 2018
(86) PCT No.: PCT/EP2018/060058

§ 371 Date: Oct. 18, 2019

(30) Foreign Application Priority Data
Apr. 21, 2017 (EP) 17167557.2

(51) Int. Cl. C08J 5/18; C08J 5/12; C08L 77/06; C09J 123/12; C09J 5/00; B29C 48/00; B29C 48/08; B29C 48/21; B29C 55/14

(52) U.S. Cl. CPC C08J 5/18; B29K 2077/00; C08L 77/06; C09J 123/12; C09J 5/00; B29C 48/0018; B29C 48/08; B29C 48/21; B29C 55/143; C08J 2377/06; C08J 2477/06; C08J 2423/12; C08L 2203/16; C08L 2201/10; C08L 2205/025; C08L 2205/03; C08L 2205/12; C09J 2423/10; C09J 2423/108; C09J 2477/008; C08J 5/128

(57) ABSTRACT

The invention relates to a process for preparing a biaxially oriented multilayered film, the film comprising at least one layer comprising a polyolefin composition and at least one layer comprising a polyamide composition, the process comprising the steps of: a) Melting a polyamide composition comprising: i. a semi-crystalline polyamide Y comprising: ⋅monomeric units derived from caprolactam in an amount of at least 75 wt %; ⋅monomeric units derived from an aliphatic diamine in an amount of between 2.5 and 12.5 wt %; ⋅monomeric units derived from an aromatic diacid in an amount of between 2.5 and 12.5 wt %; wherein the weight percentage is given with respect to the total weight of the polyamide Y; ii. an amorphous polyamide in an amount of between 2.5 and 50 wt % with respect to the total weight of the polyamide composition; wherein the amorphous polyamide comprises: ⋅monomeric units derived from an aliphatic diamine X in an amount of between 30 and 70 wt %; ⋅monomeric units derived from an aromatic diacid in an amount of between 30 and 70 wt %; wherein the weight percentage is given with respect to the total weight of the amorphous polyamide; b) Melting a composition comprising a polyolefin; c) Co-extruding at least the melts obtained from a) and b) to form a film of at least two layers; d) Cooling the film to a temperature of at most 50° C., while the film is transported in a direction, referred to as machine direction; e) Stretching the film obtained in step d) with a stretch ratio of at least 13, at a temperature between the Tg of polyamide Y and Tm of the polyolefin, wherein the stretch ratio is defined as being the product of the stretch ratio parallel to the machine direction and the stretch ratio perpendicular to the machine direction. The invention also relates to a biaxially oriented multilayered film obtainable by the process.

The invention relates to a process for preparing a biaxially oriented multilayered film, comprising at least one layer comprising a polyolefin and at least one layer comprising a polyamide composition, as well as a biaxially oriented multilayered film itself.

It is known that polyolefin films can be oriented with stretch ratios up to 24 to even 36. Such a high stretch ratio is advantageous for the mechanical properties of the polyolefin film. Polyamide films, however, can be stretched much less, such as for example to a stretch ratio of about 4 to 12. If multilayer films are desired, combining the benefits of a polyolefin layer and a polyamide layer, the stretching capabilities are thus limited to the capabilities of the polyamide layer. One solution to overcome this problem is to individually prepare and stretch the individual layers and adhere the layers after stretching. This process is also known as a lamination process and is a cumbersome procedure, as it requires preparation of at least two separate films, which have to be adhered to each other.

EP701898A1 discloses a biaxially stretched film comprising a polypropylene-based resin, an intermediate layer and a layer of a polyamide resin in which the polyamide resin comprises an aromatic polyamide. This film is prepared by co-extrusion and stretched after forming the film and exhibits a stretching ratio of at most 12. A disadvantage of this film, however, is that the film is still insufficiently stretched. It is thus an aim of the present invention to provide a process for preparing a biaxially oriented film by co-extrusion, which allows for a higher stretch ratio.

Surprisingly, this aim is achieved by a process for preparing a biaxially oriented multilayered film, the film comprising at least one layer comprising a polyolefin composition and at least one layer comprising a polyamide composition, the process comprising the steps of:
a) Melting a polyamide composition comprising:
   i. a semi-crystalline polyamide Y comprising:
      monomeric units derived from caprolactam in an amount of at least 75 wt %;
      monomeric units derived from an aliphatic diamine in an amount of between 2.5 and 12.5 wt %;
      monomeric units derived from an aromatic diacid in an amount of between 2.5 and 12.5 wt %;
   wherein the weight percentage is given with respect to the total weight of the polyamide Y;
   ii. an amorphous polyamide in an amount of between 2.5 and 50 wt % with respect to the total weight of the polyamide composition; wherein the amorphous polyamide comprises:
      monomeric units derived from an aliphatic diamine X in an amount of between 30 and 70 wt %;
      monomeric units derived from an aromatic diacid in an amount of between 30 and 70 wt %;
   wherein the weight percentage is given with respect to the total weight of the amorphous polyamide;
b) Melting a composition comprising a polyolefin;
c) Co-extruding at least the melts obtained from a) and b) to form a film of at least two layers;
d) Cooling the film to a temperature of at most 50° C., while the film is transported in a direction, referred to as machine direction;
e) Stretching the film obtained in step d) with a stretch ratio of at least 13, at a temperature between the Tg of polyamide Y and Tm of the polyolefin, wherein the stretch ratio is defined as being the product of the stretch ratio parallel to the machine direction and the stretch ratio perpendicular to the machine direction.

The process according to the invention allows for multilayered films which can be stretched more than conventional films comprising at least one layer comprising a polyolefin and at least one layer comprising a polyamide composition.

The process according to the invention comprises at least the steps of:
a) Melting a polyamide composition;
b) Melting a composition comprising a polyolefin;
c) Co-extruding at least the melts obtained from a) and b) to form a film of at least two layers;
d) Cooling the film to a temperature of at most 50° C., while the film is transported in a direction, referred to as machine direction;
e) Stretching the film obtained in step d) with a stretch ratio of at least 13, at a temperature between the Tg of polyamide Y and Tm of the polyolefin, wherein the stretch ratio is defined as being the product of the stretch ratio parallel to the machine direction and the stretch ratio perpendicular to the machine direction.

This process as such is known to a person skilled in the art and is also referred to as tubular film process such as double- or triple bubble process, as well as planar stretching process, such as simultaneously stretched film process or sequentially stretched film process. For tubular processes the stretch ratio perpendicular to the machine direction follows from the difference in diameter of the tube before and after stretching.

### Polyamide Composition

The polyamide composition provided in step a) comprises:
i. a semi-crystalline polyamide Y comprising:
   monomeric units derived from caprolactam in an amount of at least 75 wt %;
   monomeric units derived from an aliphatic diamine in an amount of between 2.5 and 12.5 wt %;
   monomeric units derived from an aromatic diacid in an amount of between 2.5 and 12.5 wt %;
wherein the weight percentage is given with respect to the total weight of the polyamide Y;
ii. an amorphous polyamide in an amount of between 2.5 and 50 wt % with respect to the total weight of the polyamide composition; wherein the amorphous polyamide comprises:
   monomeric units derived from an aliphatic diamine X in an amount of between 30 and 70 wt %;
   monomeric units derived from an aromatic diacid in an amount of between 30 and 70 wt %;
wherein the weight percentage is given with respect to the total weight of the amorphous polyamide.
   The polyamide composition comprises thus a blend of at least two polyamides.

Monomeric unit derived from caprolactam is also known by the chemical formula (1):

—HN(CH₂)₅CO— (1)

The monomeric units derived from an aliphatic diamine in the semi-crystalline polyamide Y preferably are selected from 1,4-diaminobutane, 1,5-diaminopentane, 1,6-diaminohexane and 1,7-diaminoheptane. More preferably, the monomeric units derived from an aliphatic diamine in the semi-crystalline polyamide Y is chosen from the group consisting of 1,4-diaminobutane, 1,5-diaminopentane, 1,6-diaminohexane, 1,7-diaminoheptane and combinations thereof. Even more preferred, the aliphatic diamine is 1,6-diaminohexane as this is readily available. The monomeric units derived from an aromatic diacid in the semi-crystalline polyamide Y preferably is selected from isophthalic acid (I) and terephthalic acid (T). The monomeric units derived from an aromatic diacid in the semi-crystalline polyamide Y is more preferably chosen from the group consisting of isophthalic acid (I) and terephthalic acid (T) and combinations thereof, even more preferred the aromatic diacid is terephthalic acid as terephthalic acid is readily available.

In a preferred embodiment, polyamide Y is PA-6/6T, wherein the amount of 6T is between 5 and 25 wt % with respect to the total weight of polyamide Y, preferably between 7 and 20 wt %.

Nomenclature of polyamides is as described in Nylon Plastics Handbook, Melvin I. Kohan, Hanser Publishers, 1995, page 5.

With monomeric unit is herein understood the largest constitutional unit that a single monomer molecule contributes to the structure of the polymer.

With “semi-crystalline” is herein understood a polyamide having a melting enthalpy of at least 20 Joules/gram, using differential scanning calorimetry (DSC) pursuant to ASTM D3418-08 in the second heating run with a heating rate of 10° C./min.

With “amorphous” is herein understood to be a polyamide that has a melting enthalpy of less than 20 Joules/gram.

In the polyamide composition an amorphous polyamide is present in an amount of between 2.5 and 50 wt % with respect to the total weight of the polyamide composition; wherein the amorphous polyamide comprises:
monomeric units derived from an aliphatic diamine X in an amount of between 30 and 70 wt %;
monomeric units derived from an aromatic diacid in an amount of between 30 and 70 wt %;
   wherein the weight percentage is given with respect to the total weight of the amorphous polyamide.

Preferably the amorphous polyamide is present in an amount of between 5 and 40 wt %, and most preferred between 7.5 and 25 wt %, with respect to the total weight of the polyamide composition, as this provides the best balance between stretchability and film properties such as oxygen permeability and mechanical performance.

The monomeric units derived from an aliphatic diamine X in the amorphous polyamide may preferably selected from 1,4-diaminobutane, 1,5-diaminopentane, 1,6-diaminohexane and 1,7-diaminoheptane. More preferably, the monomeric units derived from an aliphatic diamine X in the amorphous polyamide may be chosen from the group consisting of 1,4-diaminobutane, 1,5-diaminopentane, 1,6-diaminohexane and 1,7-diaminoheptane. Even more preferred, the aliphatic diamine is 1,6-diaminohexane as this is readily available.

The monomeric units derived from an aromatic diacid in the amorphous polyamide may preferably selected from isophthalic acid (I), terephthalic acid (T) and naphthalic acid. More preferred, the monomeric units derived from an aromatic diacid in the amorphous polyamide are chosen from the group consisting of isophthalic acid (I), terephthalic acid (T), naphthalic acid and combinations thereof.

In a preferred embodiment, the amorphous polyamide is PA-XI/XT, wherein X denotes the monomeric units derived from an aliphatic diamine and I and T denote monomeric units derived from an aromatic diacid isophthalic acid (I) and terephthalic acid (T) respectively. Preferably, the molar ratio isophthalic acid over terephthalic acid is between 1 and 4, more preferably between 1.5 and 3. A higher molar amount of isophthalic acid as compared to terephthalic acid is preferred in order to retaining amorphous character. Even more preferred, the amorphous polyamide is PA-6I/6T, in view of the good compatibility with the semi-crystalline polyamide and availability of hexamethylene diamine.

In another preferred embodiment, the polyamide composition employed in step a) comprises PA-6/6T and PA-XI/XT, more preferred PA-6/6T and PA-6I/6T, even more preferred substantially consists of PA-6/6T and PA-6I/6T, wherein PA-6I/6T is present in an amount of between 2.5 and 50 wt % with respect to the total weight of the polyamide composition, even more preferred in an amount of 5 and 40 wt %, most preferred between 7.5 and 25 wt %.

In the context of the present invention, the expression ‘substantially consisting of’ has the meaning of ‘may comprise a minor amount of further species’ wherein minor is up to 5 wt %, preferably of up to 2 wt % of said further species, in other words in case of the polyamide composition ‘comprising more than 95 wt % of’ preferably ‘comprising more than 98 wt % of’ polyamide Y and an amorphous polyamide. These minor amounts of further species include for example nucleating agents such as talcum and/or anti-die drool agents such as silicon oil.

The monomeric units derived from an aliphatic diamine in polyamide Y and the monomeric units derived from an aliphatic diamine X in the amorphous polyamide may be the same type of diamine but may also be different type of diamines.

“A” and “an” in the context of the present invention has the meaning of “at least one” and thus includes more than one species, such as for example at least two or at least three.

Measurement of Tg and Tm of polymers is performed by method described in ASTM D3418-03: Tg corresponds to the midpoint temperature Tmg and Tm corresponds to the melting peak temperature Tmp, as described in the section 10 of ASTM D3418-03. Both Tg and Tm are measured in a temperature scan at 10° C./min.

### Composition Comprising a Polyolefin

In step b) of the process according to the invention a composition comprising a polyolefin is melted. The composition comprising a polyolefin may substantially consist of a polyolefin. In the context of the present invention, the expression ‘substantially consisting of’ has the meaning of ‘may comprise a minor amount of further species’ wherein minor is up to 5 wt %, preferably of up to 2 wt % of said further species.

The polyolefin in the composition comprising a polyolefin may be chosen from polyethylene (PE), polypropylene (PP), polybutylene, polyoctene, polymethylpentene and copolymers thereof. Polyethylene is not limited to specific types but can be for example low density polyethylene (LDPE), linear low-density polyethylene (LLDPE) as well as mixtures thereof. Polypropylene is not limited to specific types; examples of PP homopolymers are isotactic PP, syndiotactic PP and atactic PP. It is possible to use PP homopolymers as well as copolymers of propylene and ethylene. The copolymers may be random copolymers or block copolymers. Furthermore polybutylene, polyoctene, polymethylpentene may be applied as homopolymers, more preferably as copolymers of butylene, octane or methylpentene with ethylene or propylene. The polyolefin layer may contain other ingredients such as additives. Examples of these additives are lubricants, anti-block agents, anti-fogging agents and nucleating agents. Typical amount for each additive is between 0.03 wt % and 10 wt % based on the amount of polyolefin.

### Adhesive Layer

The process according to the invention preferably further comprises a step of providing an adhesive layer between the layers originating from a) and b), by co-extruding in step c) a functionalized polyolefin.

The functionalized polyolefin may preferably be selected from maleic-anhydride functionalized polyethylene, epoxy functionalized polyethylene, maleic-anhydride functionalized polypropylene and epoxy functionalized polypropylene. The adhesive layer is provided by melting the functionalized polyolefin and subsequently co-extruding the melt in step c) together with the melts obtained from at least a) and b).

The process according to the invention includes a step c) in which the melts obtained from at least a) and b) are co-extruded to form a film of at least two layers, and a step d) cooling the film to a temperature of at most 50° C., while the film is transported in a direction, referred to as machine direction. Co-extrusion as such is a process step known in the art.

After step d) the film is stretched in step e) with a stretch ratio of at least 13, at a temperature which lies between the Tg of polyamide Y and Tm of the polyolefin, wherein the stretch ratio is defined as being the product of the stretch ratio parallel to the machine direction and the stretch ratio perpendicular to the machine direction. Preferably, the stretch ratio is at least 15, even more preferred at least 17. An upper limit of the stretch ratio is determined by the fact rupture of the film during the stretching process sets in.

Preferably, stretching is performed at a temperature of between 60° C. and 160° C.

In one embodiment, stretching in step e) may be first performed in a direction parallel to the machine direction and subsequently in a direction perpendicular to the machine direction; which is also referred to as sequential stretching.

In another embodiment, stretching in step e) may be performed simultaneously in a direction parallel to the machine direction and in a direction perpendicular to the machine direction; which is also referred to as simultaneously stretching. Simultaneously stretching for example occurs in processes such as tubular film process such as double- or triple bubble process, as well as planar simultaneously stretching processes.

The process according to the invention is a process for preparing a biaxially oriented multilayered film, comprising at least one layer comprising a polyolefin and at least one layer comprising a polyamide composition and may comprise multiple layers such as for example 3 layers or 5 or 7 layers. The number of layers usually depends on the desired use of the film and its required properties. The process for example may result in a five-layer film denoted by PP/PP-tie/PA/PP-tie/PP for each layer, in which PP refers to the layer comprising a polyolefin, PP-tie refers to an adhesive layer and PA refers to a layer comprising a polyamide composition. The process may also result in a 7-layer film such as PP/PP-tie/PA/PP-tie/PA/PP-tie/PP or PP/PP-tie/PA/EVOH/PA/PP-tie/PP, in which EVOH refers to a layer comprising ethylene vinyl alcohol. The process also may result in asymmetric film structures such as for example PP/PP-tie/PA. Total film thickness before stretching is in typical range of 100 to 400 micrometers with the PA layer thickness usually being in range of 10-60% of the total film thickness.

The invention also relates to a biaxially oriented multilayered film obtainable by the process as described above. The biaxially oriented multilayered film is particularly suitable for film applications that benefit from excellent mechanical properties in the area of stiffness, puncture resistance and tear strength, good combined oxygen and water barrier properties, high dimensional stability, good printability. Examples of application areas are the area of food packaging such as films for meat, cheese of fish packaging, lidding film, casings, pouches, as well as medical and pharmaceutical films, agricultural films, industrial films.

The invention will now be elucidated by the following examples.

### Multilayer Film Production

### Comparative Experiment 1

5-layer films were prepared by a co-extrusion cast process. Three single screw extruders were applied: single screw extruder 1: screw diameter 30 mm, L/D=30; single screw extruder 2: screw diameter 25 mm, L/D=25; single screw extruder 3: screw diameter 30 mm, L/D=25. PA-6 Tg=52.3° C. (commercial DSM PA-6 film grade F132C1) was fed to extruder 1 with barrel setting temperatures of barrel 1/2/3/4/5 240/270/265/260/267° C. respectively; screw rotation speed was 30 rpm. As adhesive layer a functionalized polyolefin being a functionalized PP material (commercial grade Yparex OH213) was fed to extruder 2 with barrel setting temperatures of barrel 1/2/3/4 170/220/230/240 C respectively; screw rotation speed was 28 rpm. Polypropylene copolymer (PP) (commercial grade Borealis RD204CF) with a Tm of 151.3° C. was fed to extruder 3 with barrel setting temperatures of barrel 1/2/3/4 170/210/220/230 C respectively; screw rotation speed was 142 rpm. The three extruders were connected to a feed block where the flow pattern of the three different types of polymers resulted in a 5-layer system: a PA-6 mid-layer, two PP layers at the outside and two PP-tie layers in between; PP/PP-tie/PA/PP-tie/PP. This feed block is connected to a film die with a slot die with adjustable die-width. Temperature setting of feed block and film die was 250° C. The length of the slot die was 300 mm and the die-width was 1 mm. The film was taken up and cooled on a chill role with a chill role temperature of 20° C. By adjusting the winding speed of the chill role to 5.1 m/min, the thickness of the 5-layer cast film was fixed at 250 μm and resulted in individual layer thicknesses of PP/PP-tie/PA/PP-tie/PP: 95/5/50/5/95 μm. The film was collected at a role and directly after production the film was packed in an alumina bag to prevent contact with moisture as much as possible.

### Comparative Experiment 2

For this comparative experiment, PA-6 material from comparative experiment 1 was replaced by a granular mixture of 80 wt % PA-6 (commercial DSM PA-6 film grade F132C1) and 20 wt % of Novamid® X21; PA-6I/6T; an amorphous polymer based on hexamethylene diamine, terephthalic acid (T) and isophthalic acid (I) with molar ratio I/T=2. Except for this polyamide material replacement, the procedure to obtain the 5-layer film was identical to the procedure as described in comparative experiment 1. The melt of the 5-layer film material at die-exit was optical transparent indicating that the mixing efficiency of the single layer extruder was sufficient to obtain proper mixing of PA-6 and PA-6I/6T at a scale smaller than the wavelength of light.

### Example 1

For this example, PA-6 material from comparative experiment 1 was replaced by a granular mixture of 90 wt % DSM product Novamid® 2620; PA-6/6T with a Tg of 57.5° C. (a copolymer based on 90 wt % caprolactam and 10 wt % 6T (6: hexamethylene diamine; T: terephthalic acid) and 10 wt % of Novamid® X21; PA-6I/6T (I/T molar ratio=2). Except for this polyamide material replacement, the procedure to obtain the 5-layer film was identical to the procedure as described in comparative experiment 1. The melt of the 5-layer film material at die-exit was optical transparent indicating that the mixing efficiency of the single layer extruder was sufficient to obtain proper mixing of Novamid® 2620 and Novamid® X21 at a scale smaller than the wavelength of light.

### Example 2

For this example, PA-6 from comparative experiment 1 was replaced by a granular mixture of 80 wt % DSM product Novamid® 2620; PA-6/6T with a Tg of 57.5° C. (a copolymer based on 90 wt % caprolactam and 10 wt % 6T (6: hexamethylene diamine; T: terephthalic acid) and 20 wt % of Novamid® X21; PA-6I/6T. Except for this polyamide material replacement, the procedure to obtain the 5-layer film was identical to the procedure as described in comparative experiment 1. The melt of the 5-layer film material at die-exit was optical transparent indicating that the mixing efficiency of the single layer extruder was sufficient to obtain proper mixing of Novamid® 2620 and Novamid® X21 at a scale smaller than the wavelength of light.

### Stretching Experiments

Comparative experiment 1

Planar sequential stretching experiments on the 5-layer films were performed on a batchwise Karo-IV laboratory stretching device as commercialized by Brueckner Machinenbau GmbH.

After opening the alumina bag containing the film role of the above described film as produced in comparative experiment 1, sheets with lateral dimensions 90*90 mm² were cut from the film and stored under dry conditions. A sheet was positioned in the clamping device of the Karo stretcher. In the first oven where the MD (machine direction) stretching step occurs, temperature setting=70° C.; in the second oven where the TD (transverse direction) stretching step occurs, temperature setting=120° C. The film is transported in the first oven and kept in this oven for 16 s. The film is stretched at a speed of 200%/s. Subsequently, the film is transported to the second oven, kept for 15 s and stretched at a stretching speed of 100%/s. The maximum stretching ratio obtained without rupture setting in is λ_{MD}*λ_{TD}=3.1*3.1=9.6. For higher stretching levels rupture of the film sets in.

### Comparative Experiment 2

Comparative experiment 1 was repeated with only one change: instead of film from comparative experiment 1 film from comparative experiment 2 was used. The maximum stretching ratio obtained without rupture setting in was λ_{MD}*λ_{TD}=2.8*4.0=11.2.

### Example 1

Comparative experiment 1 was repeated with only one change: instead of film from comparative experiment 1 film from example 1 was used. The maximum stretching ratio obtained without rupture setting in for this film was surprisingly high: λ_{MD}*λ_{TD}=3.7*4.2=15.5.

### Example 2

Comparative experiment 1 was repeated with only one change: instead of film from comparative experiment 1 film from example 1 was used. The maximum stretching ratio obtained without rupture setting was even higher compared to example 1: λ_{MD}*λ_{TD}=3.8*4.6=17.5.

These examples clearly show that the maximum level of planar stretching of these 5-layer films was governed by the layer comprising polyamide and that changes in the type of polyamides applied in the polyamide layer strongly affect the maximum level of stretching. A composition comprising PA-6/6T and PA-6I/6T clearly showed significant higher maximum stretching levels compared to the comparative experiments.

In view of the similarity of the stretching processes and conditions, it is in the line of expectation that the observed improvement in stretchability for sequential planar stretching processes also holds for simultaneous planar stretching processes and for so-called double-bubble and triple-bubble tubular stretching processes.

1. Process for preparing a biaxially oriented multilayered film, the film comprising at least one layer comprising a polyolefin composition and at least one layer comprising a polyamide composition, the process comprising the steps of:
a) Melting a polyamide composition comprising:
b) Melting a composition comprising a polyolefin;
c) Co-extruding at least the melts obtained from a) and b) to form a film of at least two layers;
d) Cooling the film to a temperature of at most 50° C., while the film is transported in a direction, referred to as machine direction;
e) Stretching the film obtained in step d) at a temperature between the Tg of polyamide Y and Tm of the polyolefin;
wherein the polyamide composition comprises:
i. a semi-crystalline polyamide Y comprising:
monomeric units derived from caprolactam in an amount of at least 75 wt %;
monomeric units derived from an aliphatic diamine in an amount of between 2.5 and 12.5 wt %;
monomeric units derived from an aromatic diacid in an amount of between 2.5 and 12.5 wt %;
wherein the weight percentage is given with respect to the total weight of the polyamide Y;
ii. an amorphous polyamide in an amount of between 2.5 and 50 wt % with respect to the total weight of the polyamide composition; wherein the amorphous polyamide comprises:
monomeric units derived from an aliphatic diamine X in an amount of between 30 and 70 wt %;
monomeric units derived from an aromatic diacid in an amount of between 30 and 70 wt %;
wherein the weight percentage is given with respect to the total weight of the amorphous polyamide;
and wherein in step e) the film is stretched with a stretch ratio of at least 13, the stretch ratio being defined as the product of the stretch ratio parallel to the machine direction and the stretch ratio perpendicular to the machine direction.

2. Process according to claim 1, wherein the amorphous polyamide comprises monomeric units derived from an aromatic diacid selected from terephthalic acid (T), isophthalic acid (I), and naphthalic acid.

3. Process according to claim 1, wherein the amorphous polyamide is PA-XI/XT, wherein X denotes the monomeric units derived from an aliphatic diamine X and I and T denote monomeric units derived from an aromatic diacid isophthalic acid (I) and terephthalic acid (T) respectively.

4. Process according to claim 3, wherein the molar ratio isophthalic acid over terephthalic acid is at least 1.5.

5. Process according to claim 1, wherein the amorphous polyamide comprises monomeric units derived from an aliphatic diamine X selected from 1,4-diaminobutane, 1,5-diaminopentane, 1,6-diaminohexane and 1,7-diaminoheptane.

6. Process according to claim 1, wherein the amorphous polyamide is PA-6I/6T.

7. Process according to claim 1, wherein the polyamide Y is PA-6/6T, wherein the amount of 6T is between 5 and 25 wt % with respect to the total weight of polyamide Y.

8. Process according to claim 1, wherein the polyamide composition employed at step a) substantially consists of PA-6/6T and PA-6I/6T.

9. Process according to claim 1, wherein the composition of step b) comprises a polyolefin selected from polyethylene, polypropylene, polybutylene, polyoctene, polymethylpentene and copolymers thereof.

10. Process according to claim 1, wherein the process further comprises a step of providing an adhesive layer between the layers originating from a) and b), by co-extruding in step c) a functionalized polyolefin.

11. Process according to claim 10, wherein the functionalized polyolefin is selected from maleic-anhydride functionalized polyethylene, epoxy functionalized polyethylene, maleic-anhydride functionalized polypropylene and epoxy functionalized polypropylene.

12. Process according to claim 1, wherein the stretching ratio is at least 15.

13. Process according to claim 1, wherein stretching in step e) is first performed in a direction parallel to the machine direction and subsequently in a direction perpendicular to the machine direction.

14. Process according to claim 1, wherein stretching in step e) is performed simultaneously in a direction parallel to the machine direction and in a direction perpendicular to the machine direction.

15. Biaxially oriented multilayered film obtainable by the process according to claim 1, comprising at least one layer comprising a polyolefin composition and at least one layer comprising a polyamide composition, and having a stretch ratio of at least 13, wherein the stretch ratio is defined as being the product of the stretch ratio parallel to the machine direction and the stretch ratio perpendicular to the machine direction,
wherein the polyamide composition comprises:
i. a semi-crystalline polyamide Y comprising:
monomeric units derived from caprolactam in an amount of at least 75 wt %;
monomeric units derived from an aliphatic diamine in an amount of between 2.5 and 12.5 wt %;
monomeric units derived from an aromatic diacid in an amount of between 2.5 and 12.5 wt %;
wherein the weight percentage is given with respect to the total weight of the polyamide Y;
ii. an amorphous polyamide in an amount of between 2.5 and 50 wt % with respect to the total weight of the polyamide composition; wherein the amorphous polyamide comprises:
monomeric units derived from an aliphatic diamine X in an amount of between 30 and 70 wt %;
monomeric units derived from an aromatic diacid in an amount of between 30 and 70 wt %;
wherein the weight percentage is given with respect to the total weight of the amorphous polyamide.
